(19) United States
(12) Patent Application Publication
(10) Pub. No.: US 2021/0229689 A1
(43) Pub. Date: Jul. 29, 2021

(54) METHOD FOR CONTROLLING VEHICLE, CONTROLLER OF VEHICLE, AND SERVER

(71) Applicant: TOYOTA JIDOSHA KABUSHIKI KAISHA, Toyota-shi (JP)

(72) Inventors: Yohsuke HASHIMOTO, Nagakute-shi (JP); Akihiro KATAYAMA, Toyota-shi (JP); Yuta OSHIRO, Nagoya-shi (JP); Kazuki SUGIE, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/151,739

(22) Filed: Jan. 19, 2021

(30) Foreign Application Priority Data
Jan. 29, 2020 (JP) 2020-012547

(51) Int. Cl. B60W 50/06; B60W 30/18

(52) U.S. Cl. CPC B60W 50/06; B60W 40/08; B60W 2540/10; B60W 30/18009

(57) ABSTRACT

A memory stores a plurality of pieces of map data. A memory of a controller stores map data. The controller executes an operation process for operating an electronic device of an internal combustion engine using the map data in the memory, and an acquisition process for acquiring a condition of a vehicle. The controller and a server execute a data changing process for selecting one of the pieces of map data stored in the memory based on the condition of the vehicle, and storing the selected map data in the memory.

### CROSS-REFERENCE TO RELATED APPLICATION

This application claims priority to Japanese Patent Application No. 2020-012547 filed on Jan. 29, 2020, incorporated herein by reference in its entirety.

### BACKGROUND

### 1. Technical Field

The present disclosure relates to a method for controlling a vehicle, a controller of a vehicle, and a server.

### 2. Description of Related Art

Japanese Unexamined Patent Application Publication No. 2013-155632 (JP 2013-155632 A) describes an example of a vehicle controller intended to suppress an increase in a vehicle speed when a vehicle is abruptly started due to an erroneous pedaling operation between an accelerator pedal and a brake pedal. In this vehicle controller, when the operation amount of the accelerator pedal at the start of the vehicle is equal to or larger than a predetermined amount, a power source of the vehicle is controlled to reduce its rotational driving force.

In the vehicle controller, the operation amount of the accelerator pedal is sequentially stored in a memory upon every satisfaction of a learning condition that the operation speed of the accelerator pedal at the start of the vehicle falls within a predetermined range. A learning value is derived based on a plurality of operation amounts stored in the memory, and is set as the predetermined amount. For example, an average of the operation amounts stored in the memory is derived as the learning value.

### SUMMARY

Habits or preferences in accelerator pedal operations for traveling of vehicles vary from person to person. When one user drives one vehicle, variations in the operation amounts stored in the memory are unlikely to increase as compared to a case where a plurality of users uses one vehicle. Therefore, the predetermined amount can converge at an appropriate value depending on the user's habit or preference. As a result, determination can accurately be made whether the erroneous pedaling operation occurs.

When a plurality of users drives a vehicle in turn, the operation amounts stored in the memory may have various tendencies. In this case, variations in the operation amounts stored in the memory increase, and the predetermined amount cannot be set to a value appropriate for a user currently driving the vehicle. Thus, there is a possibility that determination cannot appropriately be made whether the erroneous pedaling operation occurs.

In recent years, there is a demand to provide appropriate vehicle control depending on users' habits or preferences even when a plurality of users uses one vehicle.

A first aspect of the disclosure relates to a method for controlling a vehicle, the method including: operating an electronic device of the vehicle using operation data stored in a first memory, the operation data being relationship definition data that defines a relationship between a condition of the vehicle and an action variable related to an operation of the electronic device, or control mapping data created based on the relationship definition data, the relationship definition data being obtained by executing:

a process of giving a higher reward when a characteristic of the vehicle satisfies a predetermined criterion than a reward when the characteristic of the vehicle does not satisfy the predetermined criterion based on the condition of the vehicle during the operation of the electronic device that is based on a value of the action variable determined by the condition of the vehicle and the relationship definition data; and a process of updating the relationship definition data by inputting, into predetermined update mapping, the condition of the vehicle during the operation of the electronic device, the value of the action variable used in the operation of the electronic device, and the reward associated with the operation, the update mapping being configured to output the relationship definition data updated to increase an expected return for the reward when the electronic device is operated based on the relationship definition data; acquiring the condition of the vehicle based on a detection value from a sensor provided in the vehicle; and selecting one of pieces of the operation data stored in a second memory based on the acquired condition of the vehicle, and storing the selected piece of the operation data in the first memory, the pieces of the operation data stored in the second memory being a plurality of pieces of the relationship definition data updated by varying the predetermined criterion, or a plurality of pieces of the control mapping data created based on the pieces of the relationship definition data, respectively.

According to the aspect described above, the second memory stores, as the operation data, the plurality of pieces of the relationship definition data output through reinforcement learning by varying the predetermined criterion, or the plurality of pieces of the control mapping data created based on the pieces of the relationship definition data, respectively. One of the pieces of the operation data stored in the second memory is selected based on the condition of the vehicle that is acquired when the electronic device is operated through the operation process. The selected operation data is stored in the first memory.

The condition of the vehicle reflects a habit or preference of a user currently driving the vehicle. Therefore, the operation data selected based on the condition of the vehicle may be regarded as data depending on the habit or preference of the user currently driving the vehicle.

The first memory stores the operation data that is based on the condition of the vehicle, and the electronic device is operated using the operation data. Therefore, vehicle control can be performed depending on the habit or preference of the user currently driving the vehicle.

According to the aspect described above, even when a plurality of users uses one vehicle, appropriate vehicle control can be provided depending on users' habits or preferences.

In the above aspect, the pieces of the operation data stored in the second memory may include: first operation data being data updated using, as the predetermined criterion, a criterion that a parameter related to accelerator response is equal to or larger than a threshold related to the accelerator response; and second operation data being data updated using, as the predetermined criterion, a criterion that a parameter related to energy use efficiency of the vehicle is equal to or larger than a threshold related to the energy use efficiency.

According to the aspect described above, when a user driving the vehicle performs vehicle operation in which the accelerator response has priority over the energy use efficiency of the vehicle, the first operation data is stored in the first memory, and the electronic device can be operated using the first operation data. When the user driving the vehicle performs vehicle operation in which the energy use efficiency has priority over the accelerator response, the second operation data is stored in the first memory, and the electronic device can be operated using the second operation data.

In the above aspect, the condition of the vehicle may include a rate of change in an accelerator operation amount.

When the user operates the accelerator pedal, the rate of change in the accelerator operation amount tends to reflect the user's habit or preference. According to the aspect described above, the rate of change in the accelerator operation amount is acquired as the condition of the vehicle, and one of the pieces of the operation data stored in the second memory can be selected based on the condition of the vehicle and stored in the first memory. Thus, the user can be provided with vehicle control that reflects the user's habit or preference.

In the above aspect, the condition of the vehicle may include an acceleration of the vehicle.

For example, when the user operates the accelerator pedal, the acceleration of the vehicle tends to increase as the rate of change in the accelerator operation amount increases. That is, when the user operates the accelerator pedal to accelerate the vehicle, the acceleration of the vehicle tends to reflect the user's habit or preference. According to the aspect described above, the acceleration of the vehicle is acquired as the condition of the vehicle, and one of the pieces of the operation data stored in the second memory can be selected based on the condition of the vehicle and stored in the first memory. Thus, the user can be provided with vehicle control that reflects the user's habit or preference.

In the above aspect, the electronic device of the vehicle may be operated by a first processor provided in the vehicle using the operation data stored in the first memory provided in the vehicle; the condition of the vehicle based on the detection value from the sensor provided in the vehicle may be acquired by the first processor; the second memory may be provided outside the vehicle; the one of the pieces of the operation data stored in the second memory may be selected, as a selected piece of the operation data, by a second processor provided outside the vehicle; the second processor may transmit the selected piece of the operation data to the vehicle; the first processor may execute a process of causing the vehicle to receive the operation data transmitted from the second processor; and the first processor may execute a process of storing the received operation data in the first memory.

According to the aspect described above, the second memory that stores the pieces of the operation data is not provided in the vehicle. Therefore, a control load on the on-board device can be reduced as compared to a case where the second memory is provided in the vehicle.

A second aspect of the disclosure relates to a controller of a vehicle, the controller including: a first memory provided in the vehicle and configured to store operation data being used to operate an electronic device of the vehicle, the operation data being relationship definition data that defines a relationship between a condition of the vehicle and an action variable related to an operation of the electronic device, or control mapping data created based on the relationship definition data; and a first processor provided in the vehicle and configured to: operate the electronic device of the vehicle using the operation data stored in the first memory; acquire a condition of the vehicle based on a detection value from a sensor provided in the vehicle; cause the vehicle to receive the operation data selected based on the acquired condition of the vehicle and stored in a second memory provided outside the vehicle; and store the received operation data in the first memory.

In the above aspect, the operation data that is selected from a plurality of pieces of operation data stored in the second memory and is stored in the first memory may be the relationship definition data; the first processor may be configured to: update the relationship definition data stored in the first memory by executing: a reward calculation process for giving a higher reward when a characteristic of the vehicle satisfies a predetermined criterion than a reward when the characteristic of the vehicle does not satisfy the predetermined criterion based on the condition of the vehicle during an operation of the electronic device that is based on a value of an action variable determined by the condition of the vehicle and the relationship definition data; and an update process for updating the relationship definition data by inputting, into predetermined update mapping, the condition of the vehicle during the operation of the electronic device, the value of the action variable used in the operation of the electronic device, and the reward associated with the operation; and operate the electronic device based on a value of the action variable determined by the acquired condition of the vehicle and the relationship definition data stored in the first memory; and the update mapping is configured to output the relationship definition data updated to increase an expected return for the reward when the electronic device is operated based on the relationship definition data.

According to the aspect described above, after the data selected from the pieces of relationship definition data stored in the second memory is stored in the first memory, the controller performs reinforcement learning for the relationship definition data in the first memory. Thus, more appropriate vehicle control can be performed depending on a habit or preference of a user currently driving the vehicle.

A third aspect of the disclosure relates to a server, the server including: a memory configured to store a plurality of pieces of operation data configured to be used to operate an electronic device of a vehicle, the operation data being relationship definition data that defines a relationship between a condition of the vehicle and an action variable related to an operation of the electronic device, or control mapping data created based on the relationship definition data, the relationship definition data being obtained by executing: a process of giving a higher reward when a characteristic of the vehicle satisfies a predetermined criterion than a reward when the characteristic of the vehicle does not satisfy the predetermined criterion based on the condition of the vehicle during the operation of the electronic device that is based on a value of the action variable determined by the condition of the vehicle and the relationship definition data; and a process of updating the relationship definition data by inputting, into predetermined update mapping, the condition of the vehicle during the operation of the electronic device, the value of the action variable used in the operation of the electronic device, and the reward associated with the operation, the update mapping being configured to output the relationship definition data updated to increase an expected return for the reward when the electronic device is operated based on the relationship definition data; and a processor configured to select a piece of the operation data from the plurality of pieces of the operation data and transmit the selected piece of the operation data to a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a controller and a drive system according to a first embodiment;

FIG. 2 is a block diagram schematically illustrating the configuration of the controller and the configuration of a server that communicates with a vehicle;

FIG. 3 is a diagram illustrating a system configured to generate map data according to the first embodiment;

FIG. 4 is a flowchart illustrating a procedure of a process to be executed by the system according to the first embodiment;

FIG. 5 is a flowchart illustrating details of a learning process according to the first embodiment;

FIG. 6 is a flowchart illustrating a procedure of a process to be executed by the controller to operate electronic devices of the vehicle;

FIG. 7 is a flowchart illustrating a procedure of a process to be executed by the controller to rewrite the map data stored in a memory of the controller;

FIG. 8 is a flowchart illustrating a procedure of a process to be executed by the server to provide the vehicle with map data appropriate to a user's habit or preference;

FIG. 9 is a block diagram schematically illustrating the configuration of a controller and the configuration of a server according to a second embodiment;

FIG. 10 is a flowchart illustrating a procedure of a process to be executed by the controller to operate electronic devices of the vehicle; and

FIG. 11 is a block diagram illustrating a controller according to a third embodiment.

### DETAILED DESCRIPTION OF EMBODIMENTS

### First Embodiment

A method for controlling a vehicle, a controller of a vehicle, and a server according to a first embodiment are described below with reference to the drawings.

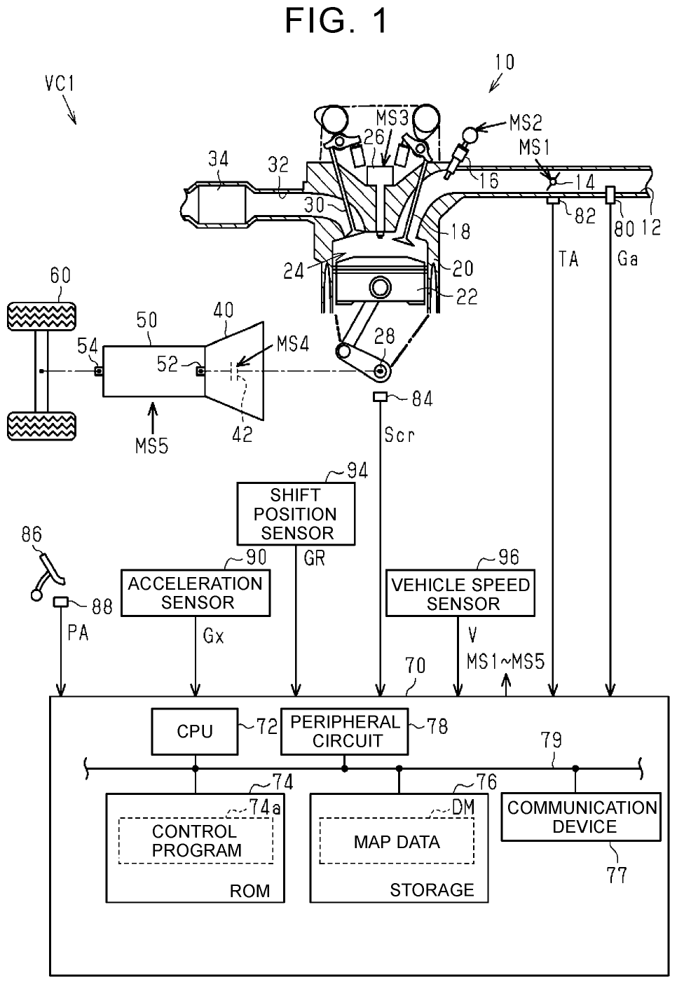

FIG. 1 illustrates the configurations of a controller 70 serving as the controller of the vehicle and a drive system of a vehicle VC1 including the controller 70.

As illustrated in FIG. 1, the vehicle VC1 includes an internal combustion engine 10 as a propulsive force generator of the vehicle VC1. An intake passage 12 of the internal combustion engine 10 is provided with a throttle valve 14 and a fuel injection valve 16 in this order from an upstream side. Air taken into the intake passage 12 and fuel injected from the fuel injection valve 16 flow into a combustion chamber 24 defined by a cylinder 20 and a piston 22 by opening an intake valve 18. In the combustion chamber 24, an air-fuel mixture containing air and fuel is burned through spark discharge by an ignition device 26. Energy generated by burning the air-fuel mixture is converted into rotational energy of a crankshaft 28 via the piston 22. The burned air-fuel mixture is discharged into an exhaust passage 32 as exhaust gas by opening an exhaust valve 30. The exhaust passage 32 is provided with a catalyst 34 as a post-processing device configured to control the exhaust gas.

An input shaft 52 of a transmission 50 can mechanically be coupled to the crankshaft 28 via a torque converter 40 including a lock-up clutch 42. The transmission 50 can change a gear ratio, which is the ratio between a rotation speed of the input shaft 52 and a rotation speed of an output shaft 54. Driving wheels 60 are mechanically coupled to the output shaft 54.

The controller 70 controls the internal combustion engine 10, and operates operation units of the internal combustion engine 10, such as the throttle valve 14, the fuel injection valve 16, and the ignition device 26, to control, for example, a torque and an exhaust gas component ratio that are control amounts of the internal combustion engine 10. The controller 70 controls the torque converter 40, and operates the lock-up clutch 42 to control an engagement condition of the lock-up clutch 42. The controller 70 controls the transmission 50, and operates the transmission 50 to control the gear ratio as its control amount. FIG. 1 illustrates operation signals MS1 to MS5 for the throttle valve 14, the fuel injection valve 16, the ignition device 26, the lock-up clutch 42, and the transmission 50. The operation units to which the operation signals MS1 to MS5 are input from the controller 70 are examples of an “electronic device”.

To control the control amounts, the controller 70 refers to an intake amount Ga, a throttle valve opening degree TA, and an output signal Scr from a crank angle sensor 84. The intake amount Ga is detected by an airflow meter 80. The throttle valve opening degree TA is an opening degree of the throttle valve 14 that is detected by the throttle sensor 82. The controller 70 refers to an accelerator operation amount PA and an acceleration Gx in a fore-and-aft direction of the vehicle VC1. The accelerator operation amount PA is an amount of depression of an accelerator pedal 86, and is detected by an accelerator sensor 88. The acceleration Gx is detected by an acceleration sensor 90. The controller 70 refers to a gear ratio GR and a vehicle speed V The gear ratio GR is detected by a shift position sensor 94. The vehicle speed V is detected by a vehicle speed sensor 96.

The controller 70 includes a central processing unit (CPU) 72, a read-only memory (ROM) 74, a memory 76 being an electrically rewritable non-volatile memory, a communication device 77, and a peripheral circuit 78, which are communicable with each other via a local network 79. The peripheral circuit 78 includes a circuit configured to generate a clock signal for defining internal operations, a power supply circuit, and a reset circuit.

The ROM 74 stores a control program 74a. The memory 76 stores map data DM. Output variables of the map data DM are a throttle valve opening degree command value TA* and a gear ratio command value GR*. The throttle valve opening degree command value TA* is a command value of the throttle valve opening degree TA. The gear ratio command value GR* is a command value of the gear ratio GR. The map data DM is a map whose input variables are a current gear ratio GR, the vehicle speed V, and time-series data of the accelerator operation amount PA and whose output variables are the throttle valve opening degree command value TA* and the gear ratio command value GR*.

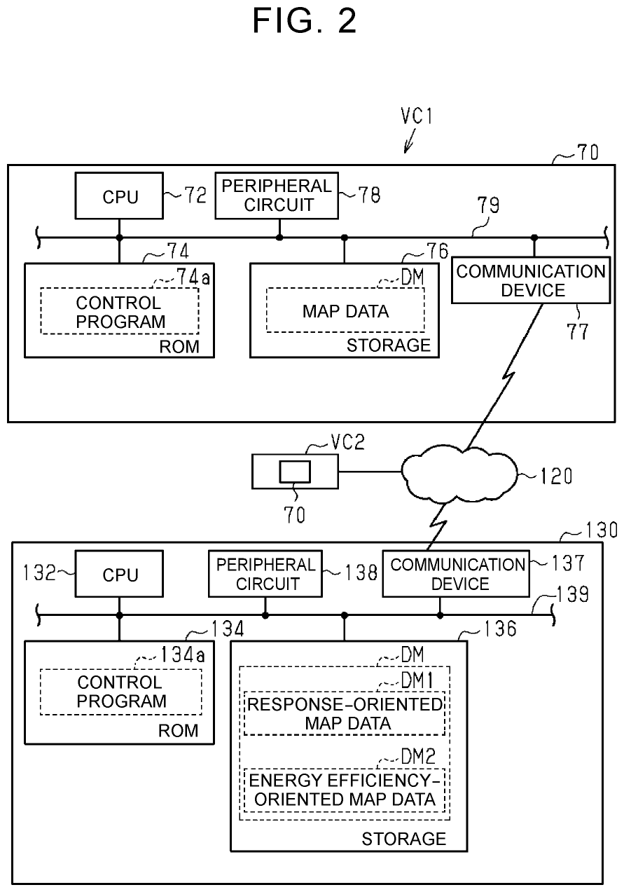

As illustrated in FIG. 2, the communication device 77 communicates with a server 130 provided outside the vehicle VC1 via a network 120 provided outside the vehicle VC1. The server 130 analyzes data transmitted from a plurality of vehicles VC1, VC2, and so on. The server 130 includes a CPU 132, a ROM 134, a memory 136 being an electrically rewritable non-volatile memory, a peripheral circuit 138, and a communication device 137, which are communicable with each other via a local network 139. The ROM 134 stores a control program 134a. The memory 136 stores map data DM. In this embodiment, the memory 136 stores response-oriented map data DM1 and energy efficiency-oriented map data DM2 as the map data DM.

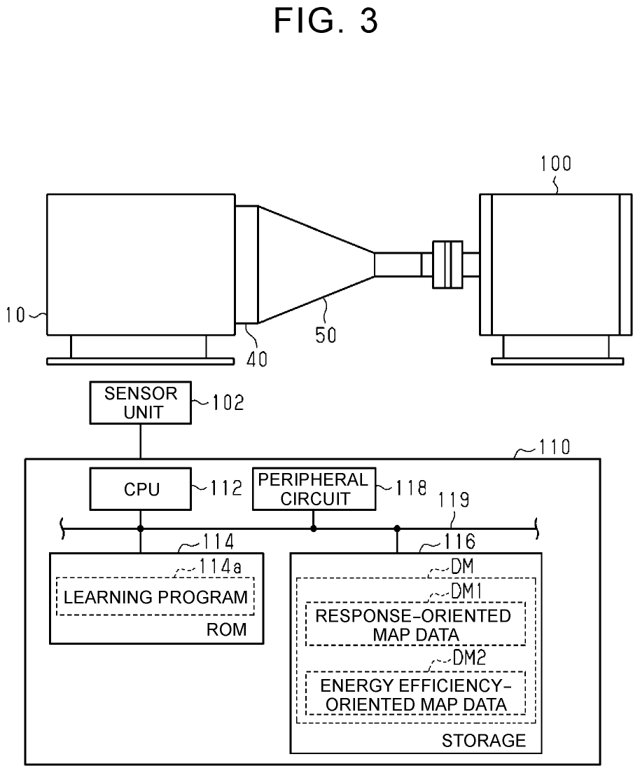

FIG. 3 illustrates a system configured to generate the map data DM.

In the system illustrated in FIG. 3, a dynamometer 100 is mechanically coupled to the crankshaft 28 of the internal combustion engine 10 via the torque converter 40 and the transmission 50. A sensor unit 102 detects various state variables when the internal combustion engine 10 is operated, and detection results are input to a generator 110, which is a computer configured to generate the map data DM. The sensor unit 102 includes the sensors mounted on the vehicle VC1 illustrated in FIG. 1.

The generator 110 includes a CPU 112, a ROM 114, a memory 116 being an electrically rewritable non-volatile memory, and a peripheral circuit 118, which are communicable with each other via a local network 119. The memory 116 stores map data DM. In this embodiment, the memory 116 stores response-oriented map data DM1 and energy efficiency-oriented map data DM2 as the map data DM. The ROM 114 stores a learning program 114a for training relationship definition data DR described later through reinforcement learning.

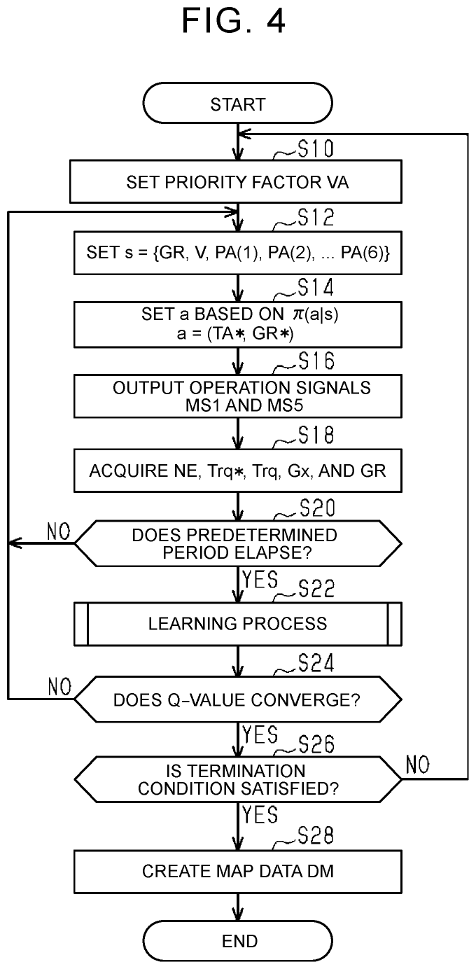

FIG. 4 illustrates a procedure of a process to be executed by the generator 110. A series of processes illustrated in FIG. 4 is implemented in a manner such that the CPU 112 executes the learning program 114a stored in the ROM 114. Step numbers of each process are hereinafter represented by numerals prefixed with “S”.

In the series of processes illustrated in FIG. 4, the CPU 112 sets a value of a priority factor VA (S10). The priority factor VA is used for determining training of any relationship definition data out of response-oriented definition data DR1 and energy efficiency-oriented definition data DR2 described later. For example, the response-oriented definition data DR1 is trained when the priority factor VA is “1”, and the energy efficiency-oriented definition data DR2 is trained when the priority factor VA is “2”.

The relationship definition data DR defines relationships between the time-series data of the accelerator operation amount PA, the vehicle speed V, and the gear ratio GR as state variables and the throttle valve opening degree command value TA* and the gear ratio command value GR* as action variables. The relationship definition data DR is derived through reinforcement learning. The response-oriented definition data DR1 is relationship definition data DR derived through the reinforcement learning such that an increase in accelerator response, that is, acceleration performance of the vehicle has priority over an increase in energy use efficiency of the vehicle. The energy efficiency-oriented definition data DR2 is relationship definition data derived through the reinforcement learning such that the increase in the energy use efficiency of the vehicle has priority over the increase in the accelerator response.

In a state in which the internal combustion engine 10 is operated, the CPU 112 acquires, as a state “s”, a vehicle speed V, a current gear ratio GR, and time-series data including six sampled values “PA(1), PA(2), . . . PA(6)” of the accelerator operation amount PA (S12). The sampled values in the time-series data are sampled at different timings. In this embodiment, the time-series data includes six sampled values adjacent to one another in time series when the values are sampled in a constant sampling period. In the system illustrated in FIG. 3, the accelerator pedal 86 does not exist. Therefore, the generator 110 generates a pseudo accelerator operation amount PA by simulating the condition of the vehicle VC1, and the generated pseudo accelerator operation amount PA is regarded as a condition of the vehicle based on a detection value from the sensor. The CPU 112 calculates the vehicle speed V as a traveling speed of the vehicle assuming that the vehicle actually exists. In this embodiment, the vehicle speed V is regarded as a condition of the vehicle based on a detection value from the sensor. Specifically, the CPU 112 calculates a rotation speed NE of the crankshaft 28 based on the output signal Scr from the crank angle sensor 84, and calculates the vehicle speed V based on the rotation speed NE and the gear ratio GR.

Next, the CPU 112 sets an action “a” including a throttle valve opening degree command value TA* and a gear ratio command value GR* depending on the state “s” acquired through the process of S12 based on a policy π determined by the response-oriented definition data DR1 or the energy efficiency-oriented definition data DR2 associated with the value of the priority factor VA set through the process of S10 (S14).

In this embodiment, the relationship definition data DR defines an action-value function Q and a policy n. In this embodiment, the action-value function Q is a table-type function showing values of expected returns depending on 10-dimensional independent variables of the state “s” and the action “a”. The policy π defines the following rule: when a state “s” is given, the best action “a” (greedy action) is preferentially selected from an action-value function Q in which the independent variables indicate the given state “s”, but any other action “a” is selected at a predetermined probability.

Specifically, the number of possible values of the independent variables of the action-value function Q according to this embodiment is that all combinations of possible values of the state “s” and the action “a” are partially reduced based on human knowledge or the like. For example, no action-value function Q is defined for a case where one of two adjacent sampled values in the time-series data of the accelerator operation amount PA is a minimum value of the accelerator operation amount PA and the other is a maximum value of the accelerator operation amount PA. The reason is that such a case cannot occur from a human operation of the accelerator pedal 86. For example, when the current gear ratio GR is second gear, possible gear ratio command values GR* serving as the action “a” are limited to first gear, second gear, and third gear to avoid an abrupt change in the gear ratio GR from second gear to fourth gear. That is, when the gear ratio GR serving as the state “s” is second gear, no action “a” is defined for fourth or higher gear. In this embodiment, the number of the possible values of the independent variables that define the action-value function Q is limited to 10⁵ or less, or desirably 10⁴ or less, through dimensionality reduction based on human knowledge or the like.

Next, based on the set throttle valve opening degree command value TA* and the set gear ratio command value GR*, the CPU 112 outputs an operation signal MS1 to the throttle valve 14 to manipulate the throttle valve opening degree TA, and outputs an operation signal MS5 to the transmission 50 to manipulate the gear ratio (S16). Next, the CPU 112 acquires a rotation speed NE, a gear ratio GR, a torque Trq of the internal combustion engine 10, a torque command value Trq* for the internal combustion engine 10, and an acceleration Gx (S18). The CPU 112 calculates the torque Trq based on a load torque generated by the dynamometer 100 and the gear ratio of the transmission 50. The torque command value Trq* is set based on the accelerator operation amount PA and the gear ratio GR. Since the gear ratio command value GR* is the action variable of the reinforcement learning, the gear ratio command value GR* is not always a value at which the torque command value Trq* is set equal to or smaller than a maximum torque that can be achieved in the internal combustion engine 10. Therefore, the torque command value Trq* is not always equal to or smaller than the maximum torque that can be achieved in the internal combustion engine 10. The CPU 112 calculates the acceleration Gx based on the load torque of the dynamometer 100 or the like as a value estimated under the assumption that the acceleration Gx is generated in a vehicle when the internal combustion engine 10 and the like are mounted on the vehicle. That is, the acceleration Gx of this embodiment is also a virtual value, but is regarded as a condition of the vehicle based on a detection value from the sensor.

Next, the CPU 112 determines whether a predetermined period elapses from a later one of the timing of execution of the process of S10 and a timing of execution of a process of S22 described later (S20). When the CPU 112 determines that the predetermined period elapses (S20: YES), the CPU 112 updates the relationship definition data DR through the reinforcement learning (S22).

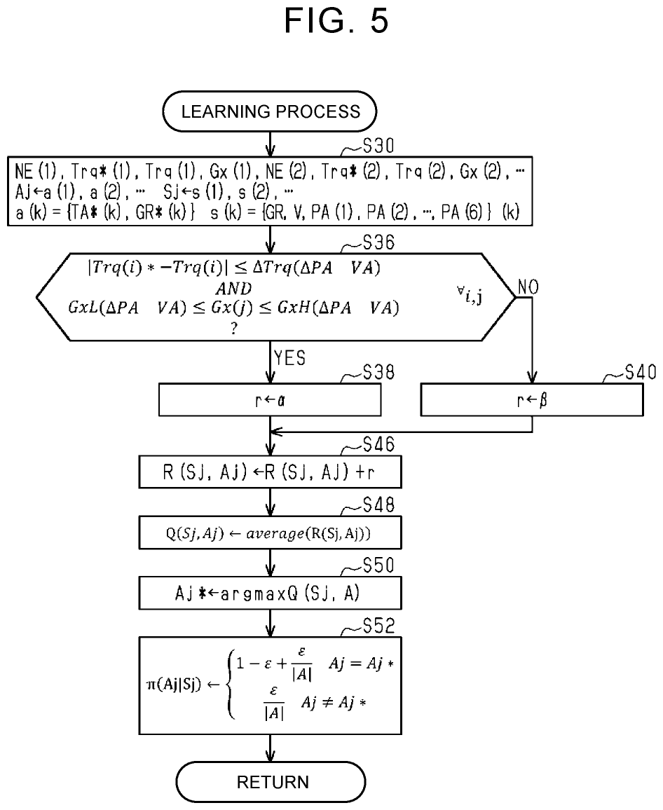

FIG. 5 illustrates details of the process of S22.

In a series of processes illustrated in FIG. 5, the CPU 112 acquires four sets of time-series data including a set of sampled values of the rotation speed NE, a set of sampled values of the torque command value Trq*, a set of sampled values of the torque Trq, and a set of sampled values of the acceleration Gx in a predetermined period, and time-series data of the state “s” and the action “a” (S30). In FIG. 5, different numerals in parentheses represent variables at different sampling timings. For example, a torque command value Trq*(1) and a torque command value Trq*(2) differ from each other in terms of their sampling timings. The time-series data of the action “a” in the predetermined period is defined as an action group Aj. The time-series data of the state “s” in the predetermined period is defined as a state group Sj.

Next, the CPU 112 determines whether a logical product of a condition (I) and a condition (II) is true (S36). The condition (I) is that an absolute value of a difference between an arbitrary torque Trq and an arbitrary torque command value Trq* in the predetermined period is equal to or smaller than a specified amount ΔTrq. The condition (II) is that an arbitrary acceleration Gx in the predetermined period is equal to or larger than a lower limit value GxL and equal to or smaller than an upper limit value GxH.

The CPU 112 variably sets the specified amount ΔTrq based on the value of the priority factor VA and a change amount ΔPA per unit time from the accelerator operation amount PA at the beginning of an episode. When the absolute value of the change amount ΔPA is large, the CPU 112 determines that the episode is in a transient period, and sets the specified amount ΔTrq to a larger value than that in a case where the episode is in a regular period. When the value of the priority factor VA indicates reinforcement learning in which an increase in the energy use efficiency of the vehicle has priority over an increase in the accelerator response, the CPU 112 sets the specified amount ΔTrq to a larger value than that in a case where the value of the priority factor VA indicates reinforcement learning in which the increase in the accelerator response has priority over the increase in the energy use efficiency of the vehicle. In the case of the reinforcement learning in which the increase in the accelerator response has priority, the absolute value of the difference between an arbitrary torque Trq and an arbitrary torque command value Trq* in the predetermined period is an example of a parameter related to the accelerator response, and the specified amount ΔTrq is an example of a threshold for the parameter related to the accelerator response. In the case of the reinforcement learning in which the increase in the energy use efficiency has priority, the absolute value of the difference between an arbitrary torque Trq and an arbitrary torque command value Trq* in the predetermined period is an example of a parameter related to the energy use efficiency, and the specified amount ΔTrq is an example of a threshold for the parameter related to the energy use efficiency.

The CPU 112 variably sets the lower limit value GxL based on the change amount ΔPA from the accelerator operation amount PA at the beginning of the episode. When the episode is in a transient period and the change amount ΔPA is positive, the CPU 112 sets the lower limit value GxL to a larger value than that in the case where the episode is in a regular period. When the episode is in a transient period and the change amount ΔPA is negative, the CPU 112 sets the lower limit value GxL to a smaller value than that in the case where the episode is in a regular period.

The CPU 112 variably sets the upper limit value GxH based on the change amount ΔPA per unit time from the accelerator operation amount PA at the beginning of the episode. When the episode is in a transient period and the change amount ΔPA is positive, the CPU 112 sets the upper limit value GxH to a larger value than that in the case where the episode is in a regular period. When the episode is in a transient period and the change amount ΔPA is negative, the CPU 112 sets the upper limit value GxH to a smaller value than that in the case where the episode is in a regular period.

The CPU 112 variably sets the lower limit value GxL and the upper limit value GxH based on the value of the priority factor VA. When the value of the priority factor VA indicates the reinforcement learning in which the increase in the accelerator response has priority over the increase in the energy use efficiency of the vehicle, the CPU 112 sets the lower limit value GxL and the upper limit value GxH such that the absolute value of the acceleration Gx in a transient period is larger than that in the case where the value of the priority factor VA indicates the reinforcement learning in which the increase in the energy use efficiency of the vehicle has priority over the increase in the accelerator response. In the case of the reinforcement learning in which the increase in the accelerator response has priority, the acceleration Gx is an example of a parameter related to the accelerator response, and the upper limit value GxH and the lower limit value GxL is an example of thresholds for the parameter related to the accelerator response. In the case of the reinforcement learning in which the increase in the energy use efficiency has priority, the acceleration Gx is an example of a parameter related to the energy use efficiency, and the upper limit value GxH and the lower limit value GxL is an example of thresholds for the parameter related to the energy use efficiency.

When the CPU 112 determines that the logical product is true (S36: YES), the CPU 112 sets a positive value a as a reward “r” (S38). When the CPU 112 determines that the logical product is false (S36: NO), the CPU 112 sets a negative value B as the reward “r” (S40). The processes of S36 to S40 are processes for giving a higher reward when a predetermined criterion is satisfied than a reward when the criterion is not satisfied. In this embodiment, the criterion is changed depending on the value of the priority factor VA as described above.

The CPU 112 updates the relationship definition data DR stored in the memory 116 illustrated in FIG. 3. In this embodiment, an on-policy Monte Carlo method for ε-soft policies is used.

That is, the CPU 112 adds the reward “r” to each return R(Sj, Aj) determined by each set of a state and an associated action that are read through the process of S30 (S46). The symbol “R(Sj, Aj)” collectively represents returns R each determined by a state that is one element of the state group Sj and an action that is one element of the action group Aj. Next, the CPU 112 averages the returns R(Sj, Aj) each determined by the set of a state and an associated action that are read through the process of S30, and substitutes a result into an associated action-value function Q(Sj, Aj) (S48). The averaging may be a process of dividing the returns R calculated through the process of S46 by the number of times the process of S46 is executed. An initial value of the return R may be “0”.

Next, the CPU 112 substitutes, into an action Aj*, an action being a set of a throttle valve opening degree command value TA* and a gear ratio command value GR* at a maximum value among action-value functions Q(Sj, A) associated with the states read through the process of S30 (S50). The symbol “A” represents a possible arbitrary action. The value of the action Aj* varies depending on the type of the state read through the process of S30, but the same symbol is used for simplification.

Next, the CPU 112 updates policies π(Aj|Sj) associated with the states read through the process of S30 (S52). When the total number of the actions is represented by “|A|”, a probability of selection of the action Aj* is expressed by “(1−ε)+ε/|A|”. A probability of selection of an action other than the action Aj* is expressed by “ε/|A|”. The process of S52 is based on the action-value function Q updated through the process of S48. Accordingly, the relationship definition data DR that defines the relationships between the state “s” and the action “a” is updated to increase the return R.

When the process of S52 is completed, the CPU 112 temporarily terminates the series of processes illustrated in FIG. 5.

Referring back to FIG. 4, when the process of S22 is completed, the CPU 112 determines whether the action-value function Q converges (S24). The CPU 112 may determine that the action-value function Q converges when the successive number of times the amount of update of the action-value function Q through the process of S22 is equal to or smaller than a predetermined value reaches a predetermined number of times. When the CPU 112 determines that the action-value function Q does not converge (S24: NO) or when the determination result in the process of S20 is negative, the CPU 112 returns to the process of S12. When the CPU 112 determines that the action-value function Q converges (S24: YES), the CPU 112 determines whether a termination condition is satisfied (S26). In this embodiment, the termination condition includes both a condition that the determination result in the process of S24 is positive when the response-oriented definition data DR1 is updated, and a condition that the determination result in the process of S24 is positive when the energy efficiency-oriented definition data DR2 is updated.

When the termination condition is not satisfied (S26: NO), the CPU 112 returns to the process of S10, and changes the priority factor VA. For example, when the priority factor VA is “1”, the CPU 112 changes the priority factor VA from “1” to “2”. When the termination condition is satisfied (S26: YES), the CPU 112 creates map data DM. That is, the CPU 112 creates response-oriented map data DM1 based on the response-oriented definition data DR1, and creates energy efficiency-oriented map data DM2 based on the energy efficiency-oriented definition data DR2 (S28). In the map data DM created based on the relationship definition data DR, a state “s” is associated in a one-to-one relationship with a value of an action variable that maximizes an expected return. Thus, the map data DM uses the state “s” as an input, and outputs the value of the action variable that maximizes the expected return. The CPU 112 stores the created map data DM in the memory 116. When the map data DM is stored, the CPU 112 terminates the series of processes illustrated in FIG. 4.

In this embodiment, the memory 136 of the server 130 stores the map data DM, that is, the response-oriented map data DM1 and the energy efficiency-oriented map data DM2 created through the reinforcement learning involving the execution of the series of processes illustrated in FIG. 4. That is, the server 130 can provide the map data DM generated by the generator 110 for the vehicles VC1, VC2, and so on, communicable with the server 130.

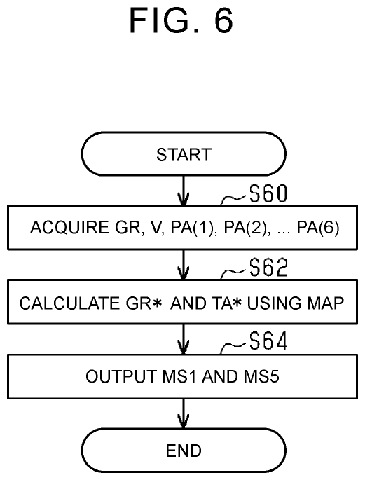

FIG. 6 illustrates a procedure of a process to be executed by the controller 70 to control the vehicle VC1. A series of processes illustrated in FIG. 6 is implemented in a manner such that the CPU 72 repeatedly executes the control program 74a stored in the ROM 74 in, for example, every predetermined period.

In the series of processes illustrated in FIG. 6, the CPU 72 acquires a vehicle speed V, a current gear ratio GR, and time-series data including six sampled values “PA(1), PA(2), . . . PA(6)” of the accelerator operation amount PA similarly to the process of S12 in FIG. 4 (S60). The CPU 72 calculates a throttle valve opening degree command value TA* and a gear ratio command value GR* using the map data DM stored in the memory 76 (S62). When the memory 76 stores the response-oriented map data DM1 as the map data DM, the CPU 72 performs the calculation using the response-oriented map data DM1. When the memory 76 stores the energy efficiency-oriented map data DM2 as the map data DM, the CPU 72 performs the calculation using the energy efficiency-oriented map data DM2. The map calculation may be performed in the following process. For example, when the values of the input variables match any values of input variables in the map data DM, values of associated output variables in the map data DM are output as a calculation result. When the values of the input variables have no match, interpolated values between a plurality of sets of values of output variables in the map data DM are output as a calculation result.

The CPU 72 outputs an operation signal MS1 to the throttle valve 14 to manipulate the throttle valve opening degree TA, and outputs an operation signal MS5 to the transmission 50 to manipulate the gear ratio (S64). This embodiment exemplifies feedback control for causing the throttle valve opening degree TA to follow the throttle valve opening degree command value TA*. Even if the throttle valve opening degree command values TA* are equal, the operation signals MS1 may differ from each other. When the process of S64 is completed, the CPU 72 temporarily terminates the series of processes illustrated in FIG. 6.

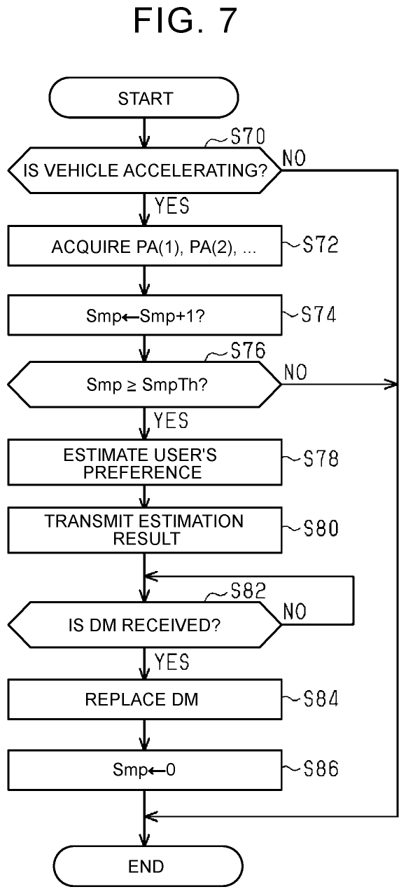

In this embodiment, when the internal combustion engine 10 is started, an estimation process is executed to estimate a user's habit or preference based on a user's operation of the vehicle such as an operation of the accelerator. The map data DM stored in the memory 76 at the start of the internal combustion engine 10 is, for example, map data DM stored in the memory 76 at the end of a previous trip of the vehicle VC1. When the habit or preference of the user currently driving the vehicle VC1 is estimated through the estimation process, an estimation result is transmitted to the server 130. The vehicle VC1 receives map data DM created based on the estimation result. The memory 76 of the controller 70 of the vehicle VC1 stores the received map data DM. FIG. 7 illustrates a procedure of a process to be executed by the controller 70 to achieve the process described above. A series of processes illustrated in FIG. 7 is implemented in a manner such that the CPU 72 repeatedly executes the control program 74a stored in the ROM 74. In this embodiment, this process is executed when the accelerator pedal 86 is operated in a situation in which the internal combustion engine 10 is operating and the shift range is a drive range (D range).

In the series of processes illustrated in FIG. 7, the CPU 72 determines whether the vehicle VC1 is accelerating along with an increase in the accelerator operation amount PA (S70). For example, the CPU 72 determines that the vehicle VC1 is accelerating when the acceleration Gx of the vehicle VC1 is equal to or larger than an acceleration threshold GxTh, and does not determine that the vehicle VC1 is accelerating when the acceleration Gx of the vehicle VC1 is smaller than the acceleration threshold GxTh. In this case, the acceleration threshold GxTh is set to a value that cannot be reached when the accelerator pedal 86 is not operated by a driver. When the CPU 72 does not determine that the vehicle VC1 is accelerating (S70: NO), the CPU 72 temporarily terminates the series of processes illustrated in FIG. 7. When the current operation of the accelerator pedal 86 by the user is finished and the user starts to operate the accelerator pedal 86 next time, the series of processes illustrated in FIG. 7 is started.

When the CPU 72 determines that the vehicle VC is accelerating (S70: YES), the CPU 72 acquires time-series data of the accelerator operation amount PA (S72). Sampled values in the time-series data are sampled at different timings. In this embodiment, the time-series data includes six sampled values adjacent to one another in time series when the values are sampled in a constant sampling period. At this time, the CPU 72 sets a reference timing, which is a timing of transition from a state in which the acceleration Gx is smaller than the acceleration threshold GxTh to a state in which the acceleration Gx is equal to or larger than the acceleration threshold GxTh, and acquires time-series data including an accelerator operation amount PA at the reference timing. Specifically, the CPU 72 acquires time-series data of the accelerator operation amount PA such that the time-series data includes accelerator operation amounts PA before the reference timing as well as the accelerator operation amount PA at the reference timing. Thus, the time-series data of the accelerator operation amount PA reflects how the accelerator operation amount PA changes to increase the acceleration Gx. When the time-series data of the accelerator operation amount PA is acquired, the CPU 72 increments a sampling count Smp by “1” (S74). The CPU 72 determines whether the sampling count Smp is equal to or larger than a sampling count threshold SmpTh (S76). A value equal to or larger than “2” (for example, “4”) is preset as the sampling count threshold SmpTh. When the sampling count Smp of the time-series data of the accelerator operation amount PA is equal to or larger than the sampling count threshold SmpTh, determination can be made that a sufficient number of samples are acquired to estimate the user's habit or preference. When the sampling count Smp is smaller than the sampling count threshold SmpTh, determination can be made that the number of samples is insufficient to estimate the user's habit or preference. Therefore, when the sampling count Smp is smaller than the sampling count threshold SmpTh (S76: NO), the CPU 72 temporarily terminates the series of processes illustrated in FIG. 7. When the current operation of the accelerator pedal 86 by the user is finished and the user starts to operate the accelerator pedal 86 next time, the series of processes illustrated in FIG. 7 is started.

When the sampling count Smp is equal to or larger than the sampling count threshold SmpTh (S76: YES), the CPU 72 estimates the habit or preference of the user currently driving the vehicle VC1 based on the plurality of pieces of acquired time-series data of the accelerator operation amount PA (S78). For example, the CPU 72 estimates whether the user gives priority to the level of the accelerator response over the level of the energy efficiency of the vehicle, or gives priority to the level of the energy efficiency of the vehicle over the level of the accelerator response. In this case, the CPU 72 may derive a rate of increase in the accelerator operation amount PA based on the acquired time-series data of the accelerator operation amount PA, and make determination based on a result of the derivation. Specifically, when determination can be made that the rate of increase in the accelerator operation amount PA is high, the CPU 72 may determine that the user gives priority to the level of the accelerator response over the level of the energy efficiency of the vehicle. When determination can be made that the rate of increase in the accelerator operation amount PA is low, the CPU 72 may determine that the user gives priority to the level of the energy efficiency of the vehicle over the level of the accelerator response.

Next, the CPU 72 transmits an estimation result obtained through the process of S78 to the server 130 via the communication device 77 (S80). The CPU 72 determines whether map data DM is received from the server 130 as a reply to the transmission of the estimation result (S82). When the map data DM is not received (S82: NO), the CPU 72 repeats the process of S82 until the map data DM is received. When the map data DM is received (S82: YES), the CPU 72 replaces the map data DM stored in the memory 76 with the map data DM received from the server 130 (S84). The CPU 72 resets the sampling count Smp to “0” (S86), and terminates the series of processes illustrated in FIG. 7. When the map data DM in the memory 76 is replaced, the series of processes illustrated in FIG. 7 is no longer executed during the current trip of the vehicle.

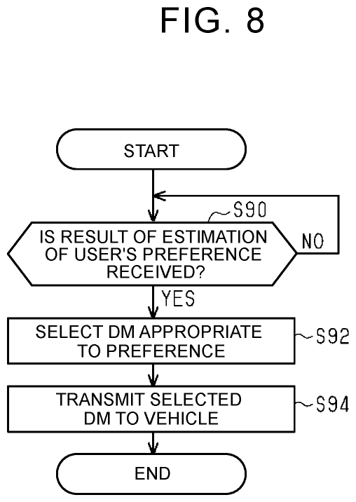

FIG. 8 illustrates a flow of a process to be executed by the server 130 that communicates with the vehicle VC1. A series of processes illustrated in FIG. 8 is implemented in a manner such that the CPU 132 repeatedly executes the control program 134a stored in the ROM 134.

In the series of processes illustrated in FIG. 8, the CPU 132 determines whether a result of estimation of a habit or preference of a user driving the vehicle VC1, that is, data transmitted through the process of S80 in FIG. 7 is received (S90). When the data is not received (S90: NO), the CPU 132 repeats the process of S90 until the data is received. When the data is received (S90: YES), the CPU 132 selects data appropriate to the user's habit or preference from the plurality of pieces of map data DM1 and DM2 stored in the memory 136 (S92). When the user driving the vehicle VC1 gives priority to the accelerator response, the CPU 132 selects the response-oriented map data DM1. When the user driving the vehicle VC1 gives priority to the energy use efficiency of the vehicle, the CPU 132 selects the energy efficiency-oriented map data DM2. The CPU 132 transmits the selected map data DM to the vehicle VC1 via the communication device 137 (S94), and temporarily terminates the series of processes illustrated in FIG. 8.

Actions and effects of this embodiment are described.

When the vehicle VCT is accelerating by operating the electronic devices of the vehicle VCT such as the throttle valve 14 and the transmission 50, time-series data of the accelerator operation amount PA is acquired. A habit or preference of a user currently driving the vehicle VC1 is estimated based on the acquired time-series data of the accelerator operation amount PA. When the estimation result is transmitted to the server 130, the server 130 selects map data DM appropriate to the estimation result from the pieces of map data DM (DM1, DM2) stored in the memory 136 of the server 130, and transmits the selected map data DM to the vehicle VC1.

The time-series data of the accelerator operation amount PA reflects the habit or preference of the user currently driving the vehicle VC1. Therefore, the map data DM selected based on the time-series data of the condition of the vehicle VC1 may be regarded as data depending on the habit or preference of the user currently driving the vehicle VC1.

In the controller 70 of the vehicle VC1, the memory 76 stores the map data DM received from the server 130. Then, vehicle control is performed using the map data DM newly stored in the memory 76. The map data DM newly stored in the memory 76 is appropriate data depending on the habit or preference of the user currently driving the vehicle VC1. Therefore, appropriate vehicle control can be provided depending on the habit or preference of the user currently driving the vehicle VC1.

In this embodiment, even when a plurality of users uses the vehicle VC1, appropriate vehicle control can be provided depending on a habit or preference of a user currently using the vehicle VC1.

In this embodiment, the following effects can further be attained.

(1) Since the memory 136 of the server 130 stores the plurality of pieces of map data DM, there is no need to store the pieces of map data DM in the memory 76 of the controller 70 of the vehicle VC1. Therefore, an increase in the memory capacity of the memory 76 of the vehicle VC1 can be suppressed.

(2) The memory 76 of the controller 70 stores the map data DM instead of the relationship definition data DR. Thus, the CPU 72 sets the throttle valve opening degree command value TA* and the gear ratio command value GR* based on the calculation using the map data DM. As a result, a calculation load on the CPU 72 can be reduced as compared to a case where the CPU 72 executes the process of selecting a throttle valve opening degree command value TA* and a gear ratio command value GR* at a maximum value among the action-value functions Q.

### Second Embodiment

A second embodiment is described below with reference to the drawings, focusing on differences from the first embodiment.

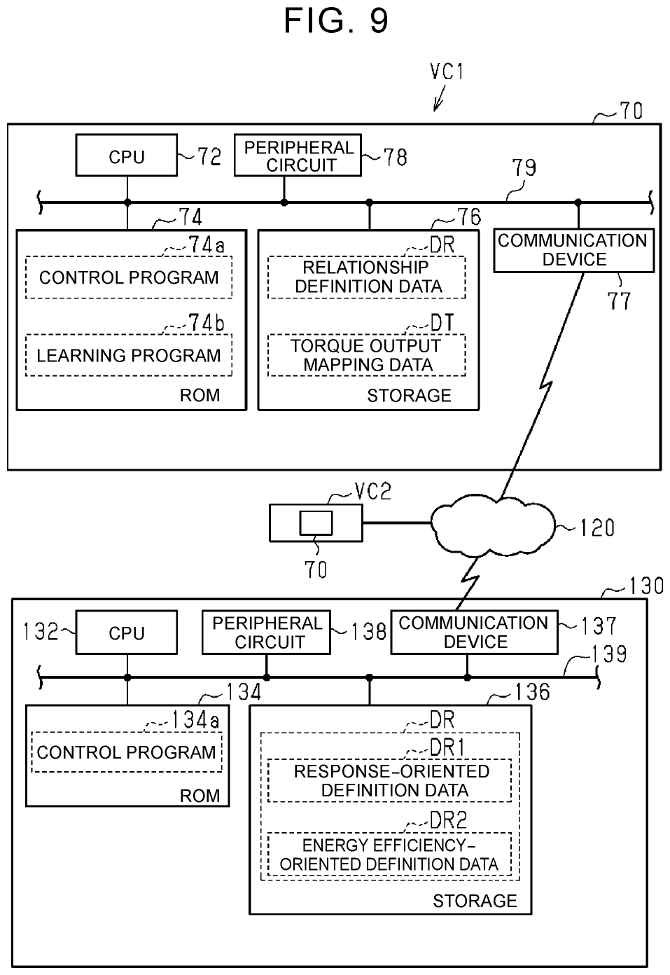

As illustrated in FIG. 9, the memory 76 of the controller 70 of the vehicle VC1 of this embodiment stores relationship definition data DR and torque output mapping data DT in place of the map data DM. The ROM 74 stores a learning program 74b in addition to the control program 74a. The learning program 74b is used for training the relationship definition data DR through reinforcement learning similarly to the learning program 114a described in the first embodiment.

Torque output mapping defined by the torque output mapping data DT is data related to a trained model such as a neural network, which uses a rotation speed NE, a charging efficiency η, and an ignition timing as inputs and outputs a torque Trq. For example, the torque output mapping data DT may be trained using, in the process of FIG. 4, a torque Trq acquired through the process of S18 as training data. The charging efficiency η may be calculated by the CPU 72 based on the rotation speed NE and an intake amount Ga.

The memory 136 of the server 130 stores response-oriented definition data DR1 and energy efficiency-oriented definition data DR2 as relationship definition data DR. The response-oriented definition data DR1 and the energy efficiency-oriented definition data DR2 stored in the memory 136 are pieces of relationship definition data derived through the series of processes illustrated in FIG. 4 and FIG. 5. Specifically, the memory 136 stores response-oriented definition data DR1 when a determination result in the process of S24 is positive in a state in which the value of the priority factor VA indicates reinforcement learning in which an increase in the accelerator response has priority over an increase in the energy use efficiency of the vehicle. The memory 136 also stores energy efficiency-oriented definition data DR2 when the determination result in the process of S24 is positive in a state in which the value of the priority factor VA indicates reinforcement learning in which the increase in the energy use efficiency of the vehicle has priority over the increase in the accelerator response.

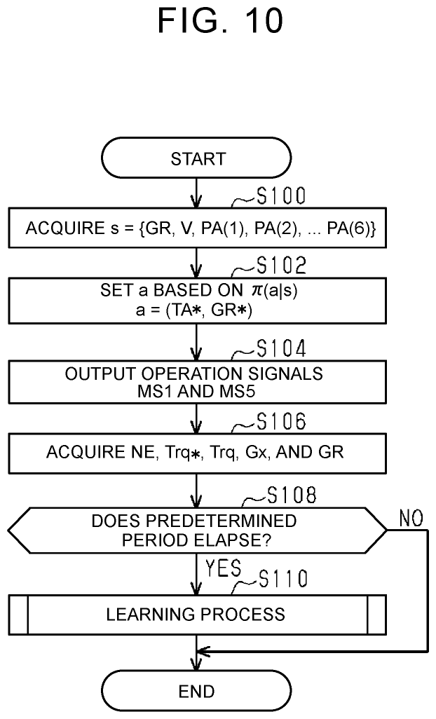

FIG. 10 illustrates a procedure of a process to be executed by the controller 70 of the vehicle VC1 to update the relationship definition data DR stored in the memory 76 while operating the electronic devices of the vehicle VC1. A series of processes illustrated in FIG. 10 is implemented in a manner such that the CPU 72 repeatedly executes the control program 74a and the learning program 74b stored in the ROM 74 in, for example, every predetermined period.

In the series of processes illustrated in FIG. 10, the CPU 72 acquires, as a state “s”, a vehicle speed V, a current gear ratio GR, and time-series data of the accelerator operation amount PA (S100). Similarly to S14 in FIG. 4, the CPU 72 sets an action “a” including a throttle valve opening degree command value TA* and a gear ratio command value GR* depending on the state “s” acquired through the process of S100 (S102). Next, based on the set throttle valve opening degree command value TA* and the set gear ratio command value GR*, the CPU 72 outputs an operation signal MS1 to the throttle valve 14 to manipulate the throttle valve opening degree TA, and outputs an operation signal MS5 to the transmission 50 to manipulate the gear ratio (S104). The CPU 72 acquires a rotation speed NE, a gear ratio GR, a torque Trq of the internal combustion engine 10, a torque command value Trq* for the internal combustion engine 10, and an acceleration Gx (S106). The CPU 72 calculates the torque Trq by inputting the rotation speed NE, a charging efficiency r, and an ignition timing to the torque output mapping. Similarly to S20 in FIG. 4, the CPU 72 determines whether a predetermined period elapses from a timing of execution of a process of S110 described later (S108). When the CPU 72 determines that the predetermined period elapses (S108: YES), the CPU 72 updates the relationship definition data DR through the reinforcement learning (S110). When the CPU 72 does not determine that the predetermined period elapses (S108: NO), the CPU 72 temporarily terminates the series of processes illustrated in FIG. 10.

Details of the process of S110 in FIG. 10 are equivalent to those of the series of processes illustrated in FIG. 5. Therefore, description of the details of the process of S110 in FIG. 10 is omitted.

In this embodiment, when the vehicle VC1 is traveling through the series of processes illustrated in FIG. 10, a habit or preference of a user currently driving the vehicle VC1 is estimated similarly to the processes of S78 and S80 in FIG. 7, and an estimation result is transmitted to the server 130. When the server 130 receives the estimation result, the server 130 selects data to be transmitted to the vehicle VC1 similarly to S92 in FIG. 8. In this embodiment, relationship definition data DR appropriate to the user's habit or preference is selected from the pieces of relationship definition data DR stored in the memory 136 of the server 130. When the relationship definition data DR is selected, the selected data is transmitted to the vehicle VC1 similarly to the process of S94 in FIG. 8. In this embodiment, the relationship definition data DR is transmitted to the vehicle VC1. In the vehicle VC1, the memory 76 stores the data received from the server 130 similarly to the process of S84 in FIG. 7. In this embodiment, the memory 76 stores the relationship definition data DR received from the server 130.

In this embodiment, the relationship definition data DR and the learning program 74b are installed in the controller 70 of the vehicle VC1. After the relationship definition data DR appropriate to the user's habit or preference is received by the vehicle VC1 from the server 130, the vehicle VC1 updates the relationship definition data DR through the reinforcement learning. As a result, vehicle control can be made closer to control depending on the user's habit or preference.

### Third Embodiment

A third embodiment is described below with reference to the drawings, focusing on differences from the first embodiment.

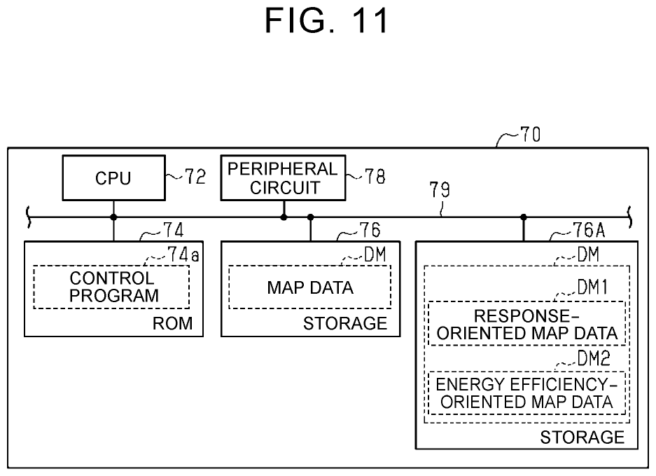

As illustrated in FIG. 11, the controller 70 of the vehicle VC1 includes the memory 76 and a memory 76A that are electrically rewritable non-volatile memories. The memory 76 stores map data DM to be used for operating the electronic devices of the vehicle VC1. The memory 76A stores response-oriented map data DM1 and energy efficiency-oriented map data DM2 as map data DM. The map data DM stored in the memory 76A is created by the system illustrated in FIG. 3.

In this embodiment, when the vehicle VC1 is traveling, a habit or preference of a user currently driving the vehicle VC1 is estimated through the series of processes illustrated in FIG. 7. The CPU 72 of the controller 70 selects map data DM appropriate to the user's habit or preference from the pieces of map data DM stored in the memory 76A. The CPU 72 stores the selected map data DM in the memory 76.

In this embodiment, the memory 76A of the vehicle VC1 stores the pieces of map data DM that are stored in the memory 136 of the server 130 in the first embodiment. Therefore, the memory 76 can store map data appropriate to a user's habit or preference without communication between the vehicle VC1 and the server 130.

### DESCRIPTION OF EXEMPLIFICATION

The CPU 72 and the ROM 74 of FIG. 2 are examples of a processor. The CPU 132 and the ROM 134 of FIG. 9 are other examples of the processor. The CPU 72 and the ROM 74 of FIG. 11 are other examples of the processor. The memories 76 of FIG. 2, FIG. 9, and FIG. 11 are examples of a first memory. The memories 136 of FIG. 2 and FIG. 9 are examples of a second memory. The memory 76A of FIG. 11 is another example of the second memory. The map data DM stored in each of the memories 76 of FIG. 2 and FIG. 11 is an example of operation data stored in the first memory. The relationship definition data DR stored in the memory 76 of FIG. 9 is another example of the operation data stored in the first memory. The pieces of map data DM1 and DM2 stored in the memory 136 of FIG. 2 are examples of a plurality of pieces of operation data stored in the second memory. The pieces of relationship definition data DR1 and DR2 stored in the memory 136 of FIG. 9 are other examples of the plurality of pieces of operation data stored in the second memory. The pieces of map data DM1 and DM2 stored in the memory 76A of FIG. 11 are other examples of the plurality of pieces of operation data stored in the second memory. The mapping defined by a command to execute the processes of S46 to S52 in FIG. 5 in the learning program 114a or 74b is an example of update mapping. The pieces of map data DM, DM1, and DM2 are examples of control mapping data. The pieces of relationship definition data DR, DR1, and DR2 are examples of relationship definition data. S64 in FIG. 6 and S104 in FIG. 10 are examples of an operation process. S60 in FIG. 6, S72 in FIG. 7, and S100 and S106 in FIG. 10 are examples of an acquisition process. S78 to S84 in FIG. 7 and S90 to S94 in FIG. 8 are examples of a data changing process. The pieces of response-oriented map data DM1 of FIG. 2 and FIG. 11 are examples of first operation data. The response-oriented definition data DR1 of FIG. 9 is another example of the first operation data. The pieces of energy efficiency-oriented map data DM2 of FIG. 2 and FIG. 11 are examples of second operation data. The energy efficiency-oriented definition data DR2 of FIG. 9 is another example of the second operation data. The CPUs 72 and the ROMs 74 of FIG. 2 and FIG. 9 are examples of a first processor. The CPUs 132 and the ROMs 134 of FIG. 2 and FIG. 9 are examples of a second processor. The controllers 70 of FIG. 2 and FIG. 9 are examples of a controller of a vehicle. The processes of S36 to S40 in FIG. 5 are examples of a reward calculation process. The processes of S46 to S52 in FIG. 5 are examples of an update process. The mapping defined by a command to execute the processes of S46 to S52 in FIG. 5 in the learning program 74b is an example of the update mapping. The servers 130 of FIG. 2 and FIG. 9 are examples of a server.

### Modified Examples

The embodiments may be modified as follows. The embodiments and the following modified examples may be combined without causing any technical contradiction.

Operation Data

In the embodiments described above, description is given of the exemplary case where the second memory stores the two pieces of operation data. The second memory may store three or more pieces or an arbitrary number of pieces of operation data if the pieces of operation data differ from one another in terms of the priority level of the accelerator response and the priority level of the energy use efficiency.

Dimensionality Reduction

For example, the accelerator operation amount PA has a maximum value in rare cases. As a method for dimensionality reduction, no action-value function Q may be defined for a state in which the accelerator operation amount PA is equal to or larger than a specified amount, and the throttle valve opening degree command value TA* and the like may be adapted separately in the case where the accelerator operation amount PA is equal to or larger than the specified amount. For example, the dimensionality reduction may be performed by excluding, from possible values of the action, an action including a throttle valve opening degree command value TA* equal to or larger than a specified value.

Relationship Definition Data

In the embodiments described above, the action-value function Q is the table-type function, but the present disclosure is not limited to this case. For example, a function approximator may be used.

For example, instead of using the action-value function Q, a policy c may be expressed by a function approximator whose independent variables are a state “s” and an action “a” and whose dependent variable is a probability of the action “a”, and parameters that define the function approximator may be updated depending on a reward “r”. In this case, different function approximators may be provided depending on values of the priority factor VA, or the priority factor VA may be included in, for example, the state “s” being the independent variable of a single function approximator.

Operation Process

For example, when a function approximator is used for the action-value function, an action “a” that maximizes the action-value function Q may be identified in a manner such that all sets of discrete values for actions being the independent variable of the table-type function of the embodiments are input to the action-value function Q together with the state “s”. For example, the identified action “a” may mainly be employed as an operation, and a different action may be selected at a predetermined probability.

For example, when a policy r is expressed by the function approximator whose independent variables are a state “s” and an action “a” and whose dependent variable is a probability of the action “a”, the action “a” may be selected based on the probability shown by the policy π.

Update Mapping

In the processes of S46 to S52, the on-policy Monte Carlo method for ε-soft policies is exemplified, but the present disclosure is not limited to this case. For example, an off-policy Monte Carlo method may be used. The present disclosure is not limited to the Monte Carlo methods. For example, an off-policy temporal difference (TD) method, or an on-policy TD method such as a state-action-reward-state-action (SARSA) method may be used. For example, an eligibility trace method may be used as on-policy learning.

For example, when a policy n is expressed using a function approximator and the function approximator is directly updated based on a reward “r”, the update mapping may be defined using a policy gradient method.

The target to be directly updated based on the reward “r” is not limited only to the action-value function Q or the policy π. For example, each of the action-value function Q and the policy π may be updated as in an actor-critic method. In the actor-critic method, the present disclosure is not limited to this case. For example, a value function may be updated in place of the action-value function Q.

Action Variable

In the embodiments described above, the throttle valve opening degree command value TA* is exemplified as the action variable related to the opening degree of the throttle valve. The present disclosure is not limited to this case. For example, a response of the throttle valve opening degree command value TA* to the accelerator operation amount PA may be expressed by a dead time and a second-order lag filter, and a total of three variables that are the dead time and two variables defining the second-order lag filter may be set as variables related to the opening degree of the throttle valve. In this case, the state variable is desirably a change amount of the accelerator operation amount PA per unit time in place of time-series data of the accelerator operation amount PA.

In the embodiments described above, the variable related to the opening degree of the throttle valve and the variable related to the gear ratio are exemplified as the action variables. The present disclosure is not limited to this case. For example, a variable related to an ignition timing or a variable related to air-fuel ratio control may be used in addition to the variable related to the opening degree of the throttle valve and the variable related to the gear ratio.

In a case of a compression-ignition internal combustion engine, a variable related to an injection amount may be used in place of the variable related to the opening degree of the throttle valve. In addition, there may be used, for example, a variable related to an injection timing, a variable related to the number of injections in one combustion cycle, or a variable related to a time interval between an end timing of one of two adjacent time-series fuel injections and a start timing of the other in one cylinder during one combustion cycle.

For example, when the transmission 50 is a stepped transmission, the action variable may be a current value of a solenoid valve configured to adjust an engagement condition of a clutch using a hydraulic pressure. When the targets to be operated based on action variables include a rotating electrical machine, the action variables may include a torque or current of the rotating electrical machine. That is, a load variable being a variable related to a load of the propulsive force generator is not limited to the variable related to the opening degree of the throttle valve or the injection amount, but may be the torque or current of the rotating electrical machine.

When the targets to be operated based on action variables include the lock-up clutch 42, the action variables may include a variable indicating an engagement condition of the lock-up clutch 42. When the action variables include the engagement condition of the lock-up clutch 42, it is particularly effective to change the value of the action variable depending on the priority level of the request to increase the energy use efficiency.

Estimation of User's Habit or Preference

In the first embodiment and the second embodiment, the server 130 may execute the process of estimating a user's habit or preference. In this case, data necessary to estimate the user's habit or preference, such as time-series data of the accelerator operation amount PA acquired in S72 of FIG. 7, is transmitted to the server 130.

Method for Generating Vehicle Control Data

In the process of S14 in FIG. 4, an action is determined based on the action-value function Q. The present disclosure is not limited to this case. All possible actions may be selected at equal probabilities.

Control Mapping Data

The control mapping data, in which a condition of the vehicle is associated in a one-to-one relationship with a value of an action variable that maximizes an expected return, and which uses the condition of the vehicle as an input and outputs the value of the action variable that maximizes the expected return, is not limited to the map data. For example, a function approximator may be used. This case can be achieved by the following method. For example, in a case of a policy gradient method, policies z are expressed by a Gaussian distribution indicating probabilities of possible values of action variables. An average of the Gaussian distribution is expressed by a function approximator, and parameters of the function approximator that expresses the average are updated. The trained average is used as control mapping data. That is, the average output from the function approximator is regarded as the value of the action variable that maximizes the expected return. In this case, different function approximators may be provided depending on values of the priority factor VA, or the priority factor VA may be included in a state “s” being the independent variable of a single function approximator.

State

In the embodiments described above, the time-series data of the accelerator operation amount PA includes six values sampled at regular intervals. The present disclosure is not limited to this case. The data may include two or more values sampled at different sampling timings. It is more desirable that the data include three or more sampled values or the sampling intervals be regular intervals.

The state variable related to the accelerator operation amount is not limited to the time-series data of the accelerator operation amount PA. For example, a change amount of the accelerator operation amount PA per unit time may be used.

The condition of the vehicle to be acquired to estimate a habit or preference of a user driving the vehicle VC1 is not limited to the time-series data of the accelerator operation amount PA. For example, the acceleration Gx of the vehicle VC1 may be acquired as the condition of the vehicle. For example, when the user operates the accelerator pedal 86, the acceleration Gx of the vehicle tends to increase as the rate of change in the accelerator operation amount PA increases. That is, when the user operates the accelerator pedal 86 to accelerate the vehicle, the acceleration Gx tends to reflect the user's habit or preference. That is, when the acceleration Gx is high during the user's operation of the accelerator pedal 86, it can be estimated that the user driving the vehicle VC1 gives higher priority to the accelerator response, as compared to a case where the acceleration Gx is low.

A state variable related to an operation amount of an on-board operation member other than the accelerator pedal 86 may be acquired, and the reinforcement learning may be performed or a habit or preference of a user driving the vehicle VC1 may be estimated based on the acquired state variable. Examples of the on-board operation member other than the accelerator pedal 86 include a brake pedal and a steering wheel.

For example, when the action variable is a current value of a solenoid valve, the states may include a rotation speed of the input shaft 52 and a rotation speed of the output shaft 54 in the transmission, and a hydraulic pressure to be adjusted by the solenoid valve. For example, when the action variable is a torque or power of a rotating electrical machine, the states may include a state of charge or a temperature of a battery. For example, when the actions include a load torque of a compressor or power consumption of an air conditioner, the states may include a temperature in a vehicle cabin.

Electronic Device

The operation unit of the internal combustion engine 10 to be operated based on an action variable is not limited to the throttle valve 14. For example, the ignition device 26 or the fuel injection valve 16 may be applied.

Among the electronic devices to be operated based on action variables, the drive-system device between the propulsive force generator and the driving wheels is not limited to the transmission 50. For example, the lock-up clutch 42 may be applied.

When a rotating electrical machine is provided as the propulsive force generator, the electronic device to be operated based on an action variable may be a power conversion circuit such as an inverter connected to the rotating electrical machine. The electronic device is not limited to the electronic device of the on-board drive system, and may be, for example, an on-board air conditioner. For example, when the on-board air conditioner is driven by rotational power of the propulsive force generator, the power of the propulsive force generator that is supplied to the driving wheels 60 depends on a load torque of the on-board air conditioner. Therefore, it is effective that the action variables include the load torque of the on-board air conditioner. For example, when the on-board air conditioner does not use the rotational power of the propulsive force generator, the energy use efficiency is affected. Therefore, it is effective to add power consumption of the on-board air conditioner to the action variables.

Processor

The processor is not limited to the device that includes the CPU and the ROM and executes the software process. For example, the processor may include a dedicated hardware circuit such as an application-specific integrated circuit (ASIC) configured to execute a hardware process in place of at least a part of the software process in the embodiments. That is, the processor may have one of the following structures (a), (b) and (c). (a) The processor includes a processing device configured to execute all the processes described above based on programs, and a program storage device such as a ROM that stores the programs. (b) The processor includes a processing device configured to execute a part of the processes described above based on programs, a program storage device, and a dedicated hardware circuit configured to execute the remaining processes. (c) The processor includes a dedicated hardware circuit configured to execute all the processes described above. A plurality of devices or circuits may be provided as the software processor including the processing device and the program storage device or as the dedicated hardware circuit.

Internal Combustion Engine

The internal combustion engine is not limited to an internal combustion engine including, as the fuel injection valve, a port injection valve configured to inject fuel into the intake passage 12. The internal combustion engine may include a direct injection valve configured to inject fuel directly into the combustion chamber 24, or may include, for example, both the port injection valve and the direct injection valve.

The internal combustion engine is not limited to a spark-ignition internal combustion engine. For example, the internal combustion engine may be a compression-ignition internal combustion engine using light oil as the fuel.

Vehicle

The vehicle is not limited to a vehicle including only an internal combustion engine as the propulsive force generator of the vehicle. For example, the vehicle may be a hybrid vehicle including both an internal combustion engine and a rotating electrical machine. For example, the vehicle may be a vehicle including only a rotating electrical machine as the propulsive force generator, as typified by an electric vehicle and a fuel cell vehicle.

What is claimed is:

1. A method for controlling a vehicle, the method comprising:
operating an electronic device of the vehicle using operation data stored in a first memory,
the operation data being relationship definition data that defines a relationship between a condition of the vehicle and an action variable related to an operation of the electronic device, or control mapping data created based on the relationship definition data,
the relationship definition data being obtained by executing:
a process of giving a higher reward when a characteristic of the vehicle satisfies a predetermined criterion than a reward when the characteristic of the vehicle does not satisfy the predetermined criterion based on the condition of the vehicle during the operation of the electronic device that is based on a value of the action variable determined by the condition of the vehicle and the relationship definition data; and
a process of updating the relationship definition data by inputting, into predetermined update mapping, the condition of the vehicle during the operation of the electronic device, the value of the action variable used in the operation of the electronic device, and the reward associated with the operation,
the update mapping being configured to output the relationship definition data updated to increase an expected return for the reward when the electronic device is operated based on the relationship definition data;
acquiring the condition of the vehicle based on a detection value from a sensor provided in the vehicle; and
selecting one of pieces of the operation data stored in a second memory based on the acquired condition of the vehicle, and storing the selected piece of the operation data in the first memory,
the pieces of the operation data stored in the second memory being a plurality of pieces of the relationship definition data updated by varying the predetermined criterion, or a plurality of pieces of the control mapping data created based on the pieces of the relationship definition data, respectively.

2. The method according to claim 1, wherein the pieces of the operation data stored in the second memory include:
first operation data being data updated using, as the predetermined criterion, a criterion that a parameter related to accelerator response is equal to or larger than a threshold related to the accelerator response; and
second operation data being data updated using, as the predetermined criterion, a criterion that a parameter related to energy use efficiency of the vehicle is equal to or larger than a threshold related to the energy use efficiency.

3. The method according to claim 1, wherein the condition of the vehicle includes a rate of change in an accelerator operation amount.

4. The method according to claim 1, wherein the condition of the vehicle includes an acceleration of the vehicle.

5. The method according to claim 1, wherein:
the electronic device of the vehicle is operated by a first processor provided in the vehicle using the operation data stored in the first memory provided in the vehicle;
the condition of the vehicle based on the detection value from the sensor provided in the vehicle is acquired by the first processor;
the second memory is provided outside the vehicle;
the one of the pieces of the operation data stored in the second memory is selected, as a selected piece of the operation data, by a second processor provided outside the vehicle;
the second processor transmits the selected piece of the operation data to the vehicle;
the first processor executes a process of causing the vehicle to receive the operation data transmitted from the second processor; and
the first processor executes a process of storing the received operation data in the first memory.

6. A controller of a vehicle, the controller comprising:
a first memory provided in the vehicle and configured to store operation data being used to operate an electronic device of the vehicle, the operation data being relationship definition data that defines a relationship between a condition of the vehicle and an action variable related to an operation of the electronic device, or control mapping data created based on the relationship definition data; and
a first processor provided in the vehicle and configured to:
operate the electronic device of the vehicle using the operation data stored in the first memory;
acquire a condition of the vehicle based on a detection value from a sensor provided in the vehicle;
cause the vehicle to receive the operation data selected based on the acquired condition of the vehicle and stored in a second memory provided outside the vehicle; and
store the received operation data in the first memory.

7. The controller according to claim 6, wherein:
the operation data that is selected from a plurality of pieces of operation data stored in the second memory and is stored in the first memory is the relationship definition data;
the first processor is configured to:
update the relationship definition data stored in the first memory by executing:
a reward calculation process for giving a higher reward when a characteristic of the vehicle satisfies a predetermined criterion than a reward when the characteristic of the vehicle does not satisfy the predetermined criterion based on the condition of the vehicle during an operation of the electronic device that is based on a value of an action variable determined by the condition of the vehicle and the relationship definition data; and
an update process for updating the relationship definition data by inputting, into predetermined update mapping, the condition of the vehicle during the operation of the electronic device, the value of the action variable used in the operation of the electronic device, and the reward associated with the operation; and
operate the electronic device based on a value of the action variable determined by the acquired condition of the vehicle and the relationship definition data stored in the first memory; and
the update mapping is configured to output the relationship definition data updated to increase an expected return for the reward when the electronic device is operated based on the relationship definition data.

8. A server comprising:
a memory configured to store a plurality of pieces of operation data configured to be used to operate an electronic device of a vehicle,
the operation data being relationship definition data that defines a relationship between a condition of the vehicle and an action variable related to an operation of the electronic device, or control mapping data created based on the relationship definition data,
the relationship definition data being obtained by executing:
a process of giving a higher reward when a characteristic of the vehicle satisfies a predetermined criterion than a reward when the characteristic of the vehicle does not satisfy the predetermined criterion based on the condition of the vehicle during the operation of the electronic device that is based on a value of the action variable determined by the condition of the vehicle and the relationship definition data; and
a process of updating the relationship definition data by inputting, into predetermined update mapping, the condition of the vehicle during the operation of the electronic device, the value of the action variable used in the operation of the electronic device, and the reward associated with the operation,
the update mapping being configured to output the relationship definition data updated to increase an expected return for the reward when the electronic device is operated based on the relationship definition data; and
a processor configured to select a piece of the operation data from the plurality of pieces of the operation data and transmit the selected piece of the operation data to a vehicle.
